(19) United States
(12) Patent Application Publication
(10) Pub. No.: US 2024/0011403 A1
(43) Pub. Date: Jan. 11, 2024

(54) CMAS-RESISTANT TOPCOAT FOR ENVIRONMENTAL BARRIER COATINGS

(71) Applicant: OERLIKON METCO (US) INC., Westbury, NY (US)

(72) Inventor: Dianying CHEN, Westbury, NY (US)

(73) Assignee: OERLIKON METCO (US) INC., Westbury, NY (US)

(21) Appl. No.: 18/271,160

(22) PCT Filed: Jan. 21, 2022
(86) PCT No.: PCT/US2022/013318

§ 371 Date: Jul. 6, 2023

Related U.S. Application Data
(60) Provisional application No. 63/140,339, filed on Jan. 22, 2021.

(51) Int. Cl. F01D 5/28; C23C 28/04

(52) U.S. Cl. CPC F01D 5/288; C23C 28/04

(57) ABSTRACT

An environmental barrier coating topcoat for improved resistance to calcium-magnesium-aluminosilicate (CMAS) degradation is disclosed. The CMAS mitigation compositions are based on spinel-containing materials. A CMAS-resistant multilayer structure on a substrate, the multi-CMAS-resistant topcoat 140 layer structure including a bond coating layer on the substrate; a hermetic EBC layer on the bond coating layer; and a CMAS-resistant topcoat layer including at least one of AB₂O₄ materials (A=Mg, Ni, Co, Cu, Mn, Ti, Zn, Be, Fe or combinations thereof; and B=Al, Fe, Cr, Co, V or combinations thereof); AB₂O₄ materials mixture with AxOy (A=Mg, Ni, Co, Cu, Mn, Ti, Zn, Be, Fe); AB₂O₄ materials mixture with BxOy (B=Al, Fe, Cr Co, V); AB₂O₄ materials mixture with RE₂Si₂O₇ or RE₂SiO₅ silicate (RE=rare earth material); AB₂O₄ with rare earth oxides-stabilized Zirconia; AB₂O₄ with rare earth oxides-stabilized Hafnia; AB₂O₄ with aluminosilicates; AB₂O₄ with rare earth garnets; and MgO, NiO, Co₂O₃, Al₂O₃.

### CROSS-REFERENCE TO RELATED APPLICATION

This application claims the benefit and priority of U.S. Provisional Application No. 63/140,339 filed Jan. 22, 2021, the disclosure of which is expressly incorporated by reference herein in its entirety.

### BACKGROUND

### 1. Field of the Disclosure

Example embodiments relate to a coating for the protection of silicon-based ceramic matrix composites (CMC). Specifically, example embodiments relate to calcium-magnesium-aluminosilicate (CMAS) resistant multilayer coating structures.

### 2. Background Information

Rare-earth silicates with the general formula RE₂SiO₅ (mono-silicates) and RE₂Si₂O₇ (di-silicates) are generally used as environmental barrier coating (EBC) material candidates. However, these materials are not always capable of protecting EBCs from CMAS attacks, which may cause reduction of the thickness of the EBCs, this phenomenon being referred to as recession.

### SUMMARY

EBCs are deposited onto Si-based CMC substrates for the protection of the CMC from oxidation and water vapor attack. In high temperature gas turbine engine environment, for example, CMAS dust penetration or chemical reaction with the EBCs may cause the EBCs to spall, and therefore to fail in protecting the underlying CMC substrate from CMAS attack.

Current EBC multilayer structures based on rare-earth silicates (RE₂SiO₅ or RE₂Si₂O₇) may not be fully capable of protecting EBCs from CMAS attack. Thus, new EBCs materials may improve their CMAS resistance properties. Other such materials are generally based on rare earth oxides-stabilized zirconia or hafnia, or rare earth silicate systems.

Example embodiments relate to a CMAS-resistant coating structure for the protection of silicon-based CMCs. In example embodiments, a multilayer ceramic coating structure including a spinel-containing material (e.g., magnesium aluminum oxide) as a topcoat substantially improves the resistance to, and reduces or eliminates the degradation of EBCs due to CMAS attack. Spinel-containing materials may be deposited on top of the rare-earth silicates EBCs in a multilayer structure to hamper or prevent, e.g., molten CMAS from penetrating or reacting with rare-earth silicates of the EBCs, and thus protect the underlying EBCs against CMAS damage, particularly at high temperature. In addition to the CMAS resistance, the spinel-containing materials, according to various example embodiments, exhibit improved steam-based recession resistance than the rare-earth silicates which often constitute the EBCs. In example embodiments, the spinel-based topcoat may significantly improve the component life, e.g., an engine component life, of ceramic matrix composites (CMC), and therefore improve the engine life, in a CMAS dust-containing environment.

In example embodiments, a multilayer coating structure having spinel-containing materials in the form of a topcoat is provided to protect underlying EBCs against CMAS attack. The spinels are a class of materials with the general formulation AB₂O₄, (A can be selected from the group of Mg, Ni, Co, Cu, Mn, Ti, Zn, Be, Fe or combinations thereof; and B can be selected from the group of Al, Fe, Cr, Co, V or combinations thereof).

In example embodiments, CMAS tests at 1300° C. show that the spinel-containing coating produced by air plasma spray (APS) process successfully prevent the CMAS penetration of the EBCs system. A CMAS test may be the exposure of the multilayer structure to a CMAS-rich environment such as, e.g., CMAS dust or material. Example of CMAS and CMFAS compositions are illustrated below in Table 1.

| | | | CMAS melting | Test |
|---|---|---|---|---|
| | Topcoat | CMAS composition | temperature | temperature |
| | Composition | (mol) | (° C.) | (° C.)/hours (h) |
| Example 1 | Spinel: 8 wt % | CaO—13MgO—8Al₂O₃—57SiO₂ | 1236 | 1300° C./8 h |
| | Al₂O₃ | | | |
| Example 2 | Spinel: 8 wt % | CaO—6MgO—14Fe₂O₃—12Al₂O₃—48SiO₂ | 1117 | 1300° C./8 h |
| | Al₂O₃ | | | |
| Example 3 | Spinel: 8 wt % | CaO—6MgO—14Fe₂O₃—12Al₂O₃—48SiO₂ | 1117 | 1350° C./8 h |
| | Al₂O₃ | | | |
| Example 4 | Spinel: 20 wt % | CaO—6MgO—14Fe₂O₃—12Al₂O₃—48SiO₂ | 1117 | 1350° C./8 h |
| | Al₂O₃ | | | |

In example embodiments the spinel-containing multilayer structure may have the following compositions:

1. AB₂O₄ materials (A=Mg, Ni, Co, Cu, Mn, Ti, Zn, Be, Fe or combinations thereof; and B=Al, Fe, Cr, Co, V or combinations thereof).

2. AB₂O₄ materials mixture with AxOy (A=Mg, Ni, Co, Cu, Mn, Ti, Zn, Be, Fe), the weight percent of AxOy in the mixture ranges from 5 wt % to 95 wt %.

3. AB₂O₄ materials mixture with BxOy (B=Al, Fe, Cr Co, V) the weight percent of BxOy in the mixture ranges from 5 wt % to 95 wt %. If the weight percent of BxOy is greater than 95%, e.g. 99%, then the advantages provided by the spinel AB₂O₄ of resistance to deterioration of the EBCs would be reduced or eliminated, and such a high weight percentage of BxOy, i.e., greater than 95%, is undesirable. If the weight percent of BxOy is less than 5 wt %, then the amount of BxOy would not be sufficient to provide the advantages of resistance to deterioration of the EBCs, and such a low weight percentage of BxOy, i.e., less than 5%, is undesirable.

4. AB₂O₄ materials mixture with RE₂Si₂O₇ or RE₂SiO₅ silicate (RE=Y, La, Ce, Sc, Pr, Nd, Pm, Sm, Eu, Gd, Tb, Dy, Ho, Er, Tm, Yb, Lu).

5. AB₂O₄ materials mixture with rare earth oxides stabilized Zirconia.

6. AB₂O₄ materials mixture with rare earth oxides stabilized Hafnia.

7. AB₂O₄ materials mixture with aluminosilicates.

8. AB₂O₄ materials mixture with rare earth garnets.

9. MgO, NiO, Co₂O₃, or Al₂O₃ only; or MgO-, NiO-, Co₂O₃-, Al₂O₃-containing materials.

10. Combinations of above.

In example embodiments, the CMAS-resistant coatings may have the configuration of a multilayer, with Si, silicide, ceramic oxides, or ceramic silicate as an underlying bonding coat. An EBC layer can include a rare earth silicate (RE₂Si₂O₇ or RE₂SiO₅), BSAS (BaO—SrO—Al₂O₃—SiO₂), Mullite, or mixture thereof. The spinel topcoat may be deposited on the above mentioned materials systems. The powder manufacturing method used to produce the coatings by thermal spraying can be either fused and crushed, agglomerated, agglomerated and sintered or blended materials.

In example embodiments, the CMAS-resistant topcoat may have a porosity ranging from 2% to 40%, and preferably from 5% to 15%. Porosities of the CMAS-resistant coating which are outside of this range may not efficiently ensure a good protection the underlying structure. For example, if the porosity if greater than 40%, then the CMAS-resistant coating may not ensure a good erosion resistance of the underlying structure. If the porosity of the CMAS-resistant coating is lower than 2%, then the topcoat is too dense and spallation could occur during thermal cycling. In example embodiments, the CMAS-resistant coating, or topcoat, has a porous vertical cracked microstructure, or a dense vertical cracked microstructure, in order to provide a higher strain tolerance in addition to CMAS-resistance. In example embodiments, the CMAS-resistant coating, or topcoat, may also be an abradable layer.

In example embodiments, the multilayer structure discussed above may be deposited using any one of Air Plasma Spray (APS), High Velocity Oxy-Fuel (HVOF), Low Pressure Plasma Spray (LPPS), Plasma Spray-Physical Vapor Deposition (PS-PVD), Chemical Vapor Deposition (CVD), Physical Vapor Deposition (PVD), Electron Beam-Physical Vapor Deposition (EB-PVD), Suspension/Solution Plasma Spray (SPS), Suspension/Solution HVOF (S-HVOF), and a slurry process.

### BRIEF DESCRIPTION OF THE DRAWINGS

The present disclosure is further described in the detailed description which follows, in reference to the noted plurality of drawings, by way of non-limiting examples of preferred embodiments of the present disclosure.

FIG. 1 illustrates a multilayer CMAS-resistant multilayer structure, according to various example embodiments.

FIG. 2 illustrates a multilayer CMAS-resistant multilayer structure, according to various example embodiments.

FIG. 3 illustrates a scanning electron microscope (SEM) image of the CMAS-resistant multilayer structure of FIG. 1, according to various example embodiments.

FIG. 4 illustrates a scanning electron microscope (SEM) image of a CMAS-resistant multilayer structure, according to various example embodiments.

FIG. 5 illustrates a scanning electron microscope (SEM) image of the CMAS-resistant multilayer structure of FIG. 4, according to various example embodiments.

FIG. 6 illustrates a scanning electron microscope (SEM) image of a CMAS-resistant multilayer structure, according to various example embodiments.

FIG. 7 illustrates a scanning electron microscope (SEM) image of a CMFAS-resistant multilayer structure, according to various example embodiments.

FIG. 8 illustrates a scanning electron microscope (SEM) image of a CMFAS-resistant multilayer structure, according to various example embodiments.

FIG. 9 illustrates a scanning electron microscope (SEM) image of a CMFAS-resistant multilayer structure, according to various example embodiments.

### DETAILED DESCRIPTION

Through one or more of its various aspects, embodiments and/or specific features of the present disclosure, are intended to bring out one or more of the advantages as specifically described above and noted below.

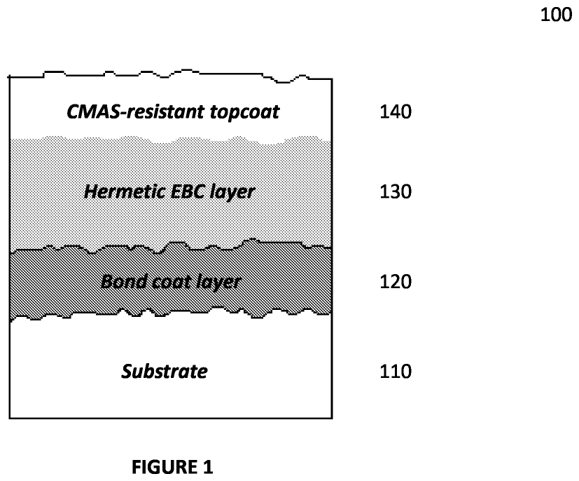

FIG. 1 illustrates a CMAS-resistant multilayer structure according to various example embodiments. In FIG. 1, the CMAS-resistant multilayer structure 100 is deposited on a substrate 110. In example embodiments, the CMAS-resistant multilayer structure 100 includes a bond coating layer 120 on the substrate 110. The bond coating layer may be or include at least one of Si; Si-Oxides (oxides=Al₂O₃, B₂O₃, HfO₂, TiO₂ TaO₂, BaO, Silicides (RESi, HfSi₂, TaSi₂, TiSi₂), RE₂Si₂O₇—Si; RE₂Si₂O₇-silicides; Mullite-Si; and Mullite-silicides, wherein RE is one of Y, La, Ce, Sc, Pr, Nd, Pm, Sm, Eu, Gd, Tb, Dy, Ho, Er, Tm, Yb, Lu.

In example embodiments, a hermetic EBC layer 130 is deposited on the bond coating layer 120, the hermetic EBC layer 130 being sufficiently dense and closed so as not to allow vapor present in, e.g., the hot gas of a turbine engine, from reaching the substrate which may be or include a ceramic matrix composite based on Si and C, known to react with vapor. The hermetic EBC layer 130 may be or include at least one of RE₂Si₂O₇, RE₂SiO₅, Mullite, and BSAS (BaO—SrO—Al₂O₃—SiO₂), where RE is one of Y, La, Ce, Sc, Pr, Nd, Pm, Sm, Eu, Gd, Tb, Dy, Ho, Er, Tm, Yb, and Lu. EBCs are deposited onto Si-based ceramic matrix composite (CMC) layers for the protection of the CMC from oxidation and water vapor attack, particularly at high temperatures. However, in the case of CMAS attacks, EBCs may be penetrated.

In example embodiments, the CMAS-resistant topcoat layer 140 is deposited on the hermetic EBC layer 130. The CMAS-resistant topcoat layer 140 may be or include at least one of AB₂O₄ materials (A=Mg, Ni, Co, Cu, Mn, Ti, Zn, Be, Fe or combinations thereof; and B=Al, Fe, Cr, Co, V or combinations thereof); AB₂O₄ materials mixture with AxOy (A=Mg, Ni, Co, Cu, Mn, Ti, Zn, Be, Fe), the weight percent of AxOy in the mixture ranges from 5 wt % to 95 wt %; AB₂O₄ materials mixture with BxOy (B=Al, Fe, Cr Co, V) the weight percent of BxOy in the mixture ranges from 5 wt % to 95 wt %; AB₂O₄ materials mixture with RE₂Si₂O₇ or RE₂SiO₅ silicate (RE=Y, La, Ce, Sc, Pr, Nd, Pm, Sm, Eu, Gd, Tb, Dy, Ho, Er, Tm, Yb, Lu); AB₂O₄ materials mixture with rare earth oxides stabilized Zirconia; AB₂O₄ materials mixture with rare earth oxides stabilized Hafnia; AB₂O₄ materials mixture with aluminosilicates; AB₂O₄ materials mixture with rare earth garnets; and MgO, NiO, Co₂O₃, Al₂O₃ only or MgO, NiO, Co₂O₃, Al₂O₃ containing materials.

In example embodiments, Table 2 illustrates structures and compositions of the CMAS-resistant multilayer structure, according to various example embodiments.

TABLE 2

| | | | Coating | |
|---|---|---|---|---|
| Layer | Materials Chemistry | | Porosity | Thickness |
| CMAS- | Spinel-containing material systems: | | 1% to 40%. | 10 μm to |
| resistant | 1. | AB₂O₄ materials (A = Mg, Ni, Co, Cu, | Preferably | 2000 μm. |
| topcoat | | Mn, Ti, Zn, Be, Fe or combinations | 5-25%. | Preferably |
| | | thereof; and B = Al, Fe, Cr, Co, V or | more | 50-250 μm. |
| | | combinations thereof). | preferably | more |
| | 2. | AB₂O₄ materials mixture with AxOy | 5-20% | preferably |
| | | (A = Mg, Ni, Co, Cu, Mn, Ti, Zn, Be, | | 100 μm-200 μm. |
| | | Fe), the weight percent of AxOy in the | | |
| | | mixture ranges from 5 wt % to 95 wt %. | | |
| | 3. | AB₂O₄ materials mixture with BxOy | | |
| | | (B = Al, Fe, Cr Co, V) the weight | | |
| | | percent of BxOy in the mixture ranges | | |
| | | from 5 wt % to 95 wt %. | | |
| | 4. | AB₂O₄ materials mixture with | | |
| | | RE₂Si₂O₇ or RE₂SiO₅ silicate (RE = Y, | | |
| | | La, Ce, Sc, Pr, Nd, Pm, Sm, Eu, Gd, | | |
| | | Tb, Dy, Ho, Er, Tm, Yb, Lu). | | |
| | 5. | AB₂O₄ materials mixture with rare | | |
| | | earth oxides stabilized Zirconia. | | |
| | 6. | AB₂O₄ materials mixture with rare | | |
| | | earth oxides stabilized Hafnia. | | |
| | 7. | AB₂O₄ materials mixture with | | |
| | | aluminosilicates. | | |
| | 8. | AB₂O₄ materials mixture with rare | | |
| | | earth garnets. | | |
| | 9. | In one extreme case, the material can | | |
| | | be MgO, NiO, Co₂O₃, Al₂O₃ only or | | |
| | | MgO, NiO, Co₂O₃, Al₂O₃ containing | | |
| | | materials. | | |
| | 10. | Combination of above | | |
| Hermetic | 1. | RE₂Si₂O₇ | <10%. | 10 μm to |
| EBCs | 2. | RE₂SiO₅ | Preferably | 1000 μm. |
| layer to | 3. | Mullite | <5%. | Preferably |
| block | 4. | BSAS (BaO—SrO—Al₂O₃—SiO₂) | | 50 μm-250 μm. |
| oxygen | 5. | Combination of above | | |
| and steam | (RE = Y, La, Ce, Sc, Pr, Nd, Pm, Sm, Eu, | | | |
| diffusion | Gd, Tb, Dy, Ho, Er, Tm, Yb, Lu) | | | |
| Bond | 1. | Si | <10%. | 2 μm to |
| coating | 2. | Si-Oxides (oxides = Al₂O₃, B₂O₃, HfO₂, | Preferably | 500 μm. |
| layer | | TiO₂ TaO₂, BaO, SrO) | <5%. | Preferably |
| | 3. | Silicides (RESi, HfSi₂, TaSi₂, TiSi₂) | | 25 μm to |
| | 4. | RE₂Si₂O₇—Si | | 200 μm |
| | 5. | RE₂Si₂O₇-silicides | | |
| | 6. | Mullite-Si | | |
| | 7. | Mullite-silicides | | |
| | 8. | Combination of above | | |

| | | |
|---|---|---|
| | (RE = Y, La, Ce, Sc, Pr, Nd, Pm, Sm, Eu, | |
| | Gd, Tb, Dy, Ho, Er, Tm, Yb, Lu) | |
| Substrate | SiC, Si₃N₄ | >40 mil |

In example embodiments, the coating processes for coating the CMAS-resistant topcoat, the hermetic EBCs or the bond coating layer include Air Plasma Spray (APS), High Velocity Oxy-Fuel (HVOF), Low Pressure Plasma Spray (LPPS), Plasma Spray-Physical Vapor Deposition (PS-PVD), Chemical Vapor Deposition (CVD), Physical Vapor Deposition (PVD), Electron Beam-Physical Vapor Deposition (EB-PVD), Suspension/Solution Plasma Spray (SPS), Suspension/Solution HVOF (S-HVOF), and a slurry process. For example, as illustrated in Table 3 below, the APS process may include the following parameters.

TABLE 3

| | | | CMAS-resistant |
|---|---|---|---|
| | | Yb2Si2O7 | Spinel-containing |
| | Si Bond Coat | Hermetic Layer | Topcoat |
| Current (A) | 450 ± 50 | 500 ± 50 | 520 ± 50 |
| Voltage (V) | 96.6 ± 5 | 97 ± 5 | 86 ± 5 |
| Power (kW) | 44.3 ± 5 | 50 ± 5 | 45 ± 5 |
| Ar (nlpm) | 75 ± 10 | 70 ± 10 | 40 ± 10 |
| H₂ (nlpm) | 5 ± 3 | 5 ± 3 | 5 ± 3 |
| Powder feeding rate | 10-50 | 10-50 | 5-70 |
| (g/min) | | | |
| Coating thickness | 200 ± 100 | 200 ± 100 | 225 ± 100 |
| (μm) | | | |

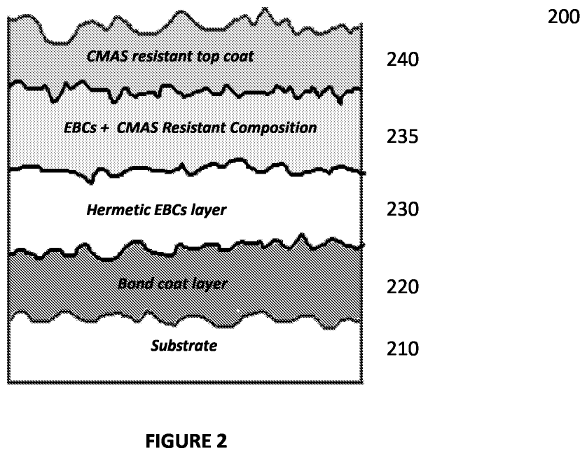

FIG. 2 illustrates a multilayer CMAS-resistant multilayer structure 200, according to various example embodiments. In FIG. 2, the CMAS-resistant multilayer structure 200 includes a bond coating layer 220 on the substrate 210, a hermetic EBC layer 230 is deposited on the bond coating layer 220, and a CMAS-resistant topcoat layer 240 is deposited on the overall multilayer structure. In FIG. 2, the layers 210-240 are similar to layers 110-140 illustrated in FIG. 1, except that a buffer layer 235 is disposed between the hermetic EBC layer 230 and the CMAS-resistant topcoat layer 240. In example embodiments, the buffer layer 235 includes a mixture of a certain percentage of a compound similar to the EBC layer 230 and a certain percentage of a compound similar to the CMAS-resistant topcoat layer 240.

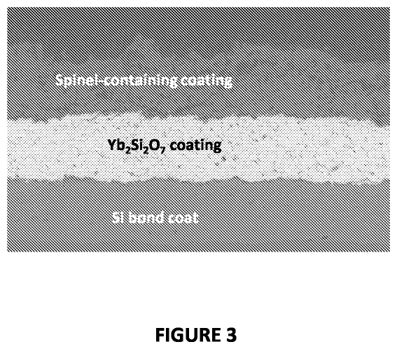

FIG. 3 illustrates a scanning electron microscope (SEM) image of a CMAS-resistant multilayer structure, according to various example embodiments. In FIG. 3, the CMAS-resistant multilayer structure includes a Spinel-Al₂O₃ as a topcoat, a Yb₂Si₂O₇ layer as an intermediate EBC, Si as a bonding coat, on a SiC ceramic substrate, according to various example embodiments. Specifically, the CMAS-resistant layer includes a spinel-containing coating,

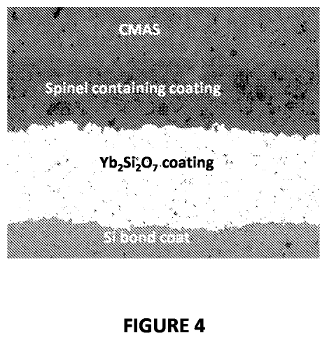

FIG. 4 illustrates a scanning electron microscope (SEM) image of a CMAS-resistant multilayer structure, according to various example embodiments. In FIG. 4, the CMAS-resistant multilayer structure is the one illustrated in FIG. 3 after a CMAS test at 1300° C. for 8 hours has been conducted, according to various example embodiments. A comparison of FIGS. 3 and 4 reveals that the spinel-containing topcoat successfully prevented the CMAS penetration of the EBCs system.

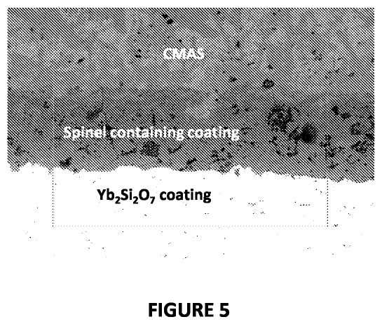

FIG. 5 illustrates a scanning electron microscope (SEM) image of a CMAS-resistant multilayer structure, according to various example embodiments. In FIG. 5, the CMAS-resistant multilayer structure is the one illustrated in FIGS. 3 and 4, and shows an area for Calcium (Ca) mapping. Ca mapping is performed using an EDS (Energy-Dispersive X-ray Spectroscopy) on the cross-section, to determine whether there are some elements, e.g., Ca, which is a constituent of CMAS, which penetrated the coating system. In the case of the CMAS-resistant layer, there is no detected presence of Ca inside the coating, showing that the external CMAS attack did not penetrate and damage the coating.

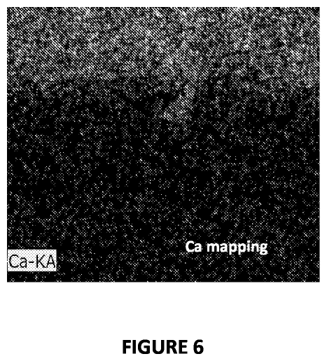

FIG. 6 illustrates a scanning electron microscope (SEM) image of a CMAS-resistant multilayer structure, according to various example embodiments. In FIG. 6, the CMAS-resistant multilayer structure is the one illustrated in FIGS. 3-5 and shows that the CMAS did not reach the Yb₂Si₂O₇ layer and stopped at the spinel-Al₂O₃/CMAS interface, according to various example embodiments. In FIG. 6, the dark area of the Ca mapping shows no presence of Ca, and the CMAS is only present on the surface of the protective top layer which is also dark, thus showing the protective effect of the CMAS-resistant layer.

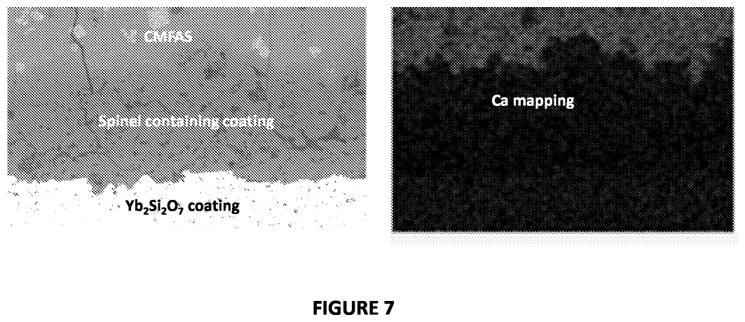

FIG. 7 illustrates a scanning electron microscope (SEM) image of a CMFAS-resistant multilayer structure, according to various example embodiments. CMFAS stands for calcium-magnesium-iron-alumino-silicate and in this case is (CaO—6 MgO—14 FeO—12 Al₂O₃—48% O₂). FIG. 7 illustrates the SEM cross-section of a CMAS-resistant multilayer structure having Spinel-8 wt % Al₂O₃ as topcoat after a CMFAS attack (alternative test) after 8 hours at 1300° C., and the corresponding Ca mapping showing that the Ca element is not present in the CMAS-resistant coating. On the left-hand side of FIG. 7, the multilayer structure includes an EBC with a topcoat including spinel-8 wt % Al₂O₃, Yb₂Si₂O₇ layer as an intermediate EBC layer, Si as a bonding coat, on a SiC ceramic substrate, according to various example embodiments. The multilayer structure is exposed to CMFAS at 1300° C. for 8 hours. The right-hand side illustrates Ca element mapping that shows that the CMFAS did not reach the Yb₂Si₂O₇ EBC layer and was stopped at the spinel-8 wt % Al₂O₃ layer/CMFAS interface. Accordingly, the spinel-8 wt % Al₂O₃ coating successfully prevented the CMFAS from penetrating the EBC layer even after 8 hours at 1300° C.

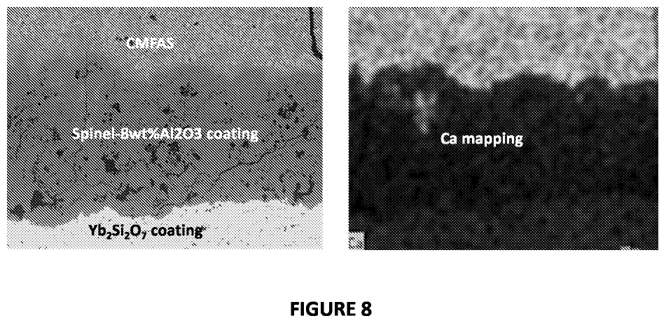

FIG. 8 illustrates a scanning electron microscope (SEM) image of a CMFAS-resistant multilayer structure, according to various example embodiments. CMFAS in this case is (CaO—6 MgO—14 FeO—12 Al₂O₃—48 SiO₂). FIG. 8 illustrates the SEM cross-section of a CMAS-resistant multilayer structure having Spinel-8 wt % Al₂O₃ as topcoat after a CMFAS attack (alternative test) after 8 hours at 1350° C. and the corresponding Ca mapping. On the left-hand side of FIG. 8, the multilayer structure includes an EBC with a topcoat including spinel-8 wt % Al₂O₃, Yb₂Si₂O₇ layer as an intermediate EBC layer, Si as a bonding coat, on a SiC ceramic substrate, according to various example embodiments. The multilayer structure is exposed to CMFAS at 1350° C. for 8 hours. The right-hand side illustrates Ca element mapping that shows that the CMFAS did not reach the Yb₂Si₂O₇ EBC layer and was stopped at the spinel-8 wt % Al₂O₃ layer/CMFAS interface. Accordingly, the spinel-8 wt % Al₂O₃ coating successfully prevented the CMFAS from penetrating the EBC layer even after 8 hours at 1350° C.

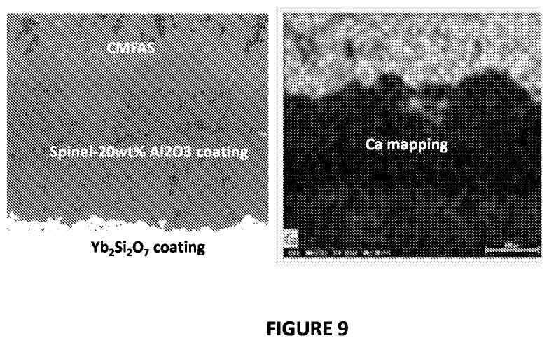

FIG. 9 illustrates a scanning electron microscope (SEM) image of a CMFAS-resistant multilayer structure, according to various example embodiments. CMFAS in this case is (CaO—6 MgO—14 FeO—12 Al₂O₃—48 SiO₂). FIG. 9 illustrates the SEM cross-section of a CMAS-resistant multilayer structure having Spinel-20 wt % Al₂O₃ as topcoat after a CMFAS attack (alternative test) after 8 hours at 1350° C. and the corresponding Ca mapping. On the left-hand side of FIG. 9, the multilayer structure includes an EBC with a topcoat including spinel-20 wt % Al₂O₃, Yb₂Si₂O₇ layer as an intermediate EBC layer, Si as a bonding coat, on a SiC ceramic substrate, according to various example embodiments. The multilayer structure is exposed to CMFAS at 1350° C. for 8 hours. The right-hand side illustrates Ca element mapping that shows that the CMFAS did not reach the Yb₂Si₂O₇ EBC layer and was stopped at the spinel-20 wt % Al₂O₃ layer/CMFAS interface. Accordingly, the spinel-20 wt % Al₂O₃ coating successfully prevented the CMFAS from penetrating the EBC layer even after 8 hours at 1350° C.

The illustrations of the embodiments described herein are intended to provide a general understanding of the various embodiments. The illustrations are not intended to serve as a complete description of the entirety of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A CMAS-resistant multilayer structure on a substrate, the multilayer structure comprising:
a bond coating layer on the substrate;
a hermetic environmental barrier coating (EBC) layer on the bond coating layer; and
a CMAS-resistant topcoat layer including at least one of:
AB₂O₄ materials (A=Mg, Ni, Co, Cu, Mn, Ti, Zn, Be, Fe or combinations thereof; and B=Al, Fe, Cr, Co, V or combinations thereof);
AB₂O₄ materials mixture with AxOy (A=Mg, Ni, Co, Cu, Mn, Ti, Zn, Be, Fe), the weight percent of AxOy in the mixture ranges from 5 wt % to 95 wt %;
AB₂O₄ materials mixture with BxOy (B=Al, Fe, Cr Co, V) the weight percent of BxOy in the mixture ranges from 5 wt % to 95 wt %;
AB₂O₄ materials mixture with RE₂Si₂O₇ or RE₂SiO₅ silicate (RE=Y, La, Ce, Sc, Pr, Nd, Pm, Sm, Eu, Gd, Tb, Dy, Ho, Er, Tm, Yb, Lu);
AB₂O₄ materials mixture with rare earth oxides stabilized Zirconia;
AB₂O₄ materials mixture with rare earth oxides stabilized Hafnia;
AB₂O₄ materials mixture with aluminosilicates;
AB₂O₄ materials mixture with rare earth garnets; and
MgO, NiO, Co₂O₃, Al₂O₃ only or MgO, NiO, Co₂O₃, Al₂O₃ containing materials.

2. The CMAS-resistant multilayer structure of claim 1, wherein the hermetic environmental barrier coating (EBC) layer comprises at least one of RE₂Si₂O₇, RE₂SiO₅, Mullite, and BSAS (BaO—SrO—Al₂O₃—SiO₂);
wherein RE is one of Y, La, Ce, Sc, Pr, Nd, Pm, Sm, Eu, Gd, Tb, Dy, Ho, Er, Tm, Yb, and Lu.

3. The CMAS-resistant multilayer structure of claim 1, wherein the bond coating layer comprises at least one of Si; Si-Oxides (oxides=Al₂O₃, B₂O₃, HfO₂, TiO₂ TaO₂, BaO, SrO), Silicides (RESi, HfSi₂, TaSi₂, TiSi₂), RE₂Si₂O₇—Si; RE₂Si₂O₇-silicides; Mullite-Si; and Mullite-silicides, wherein Re is one of Y, La, Ce, Sc, Pr, Nd, Pm, Sm, Eu, Gd, Tb, Dy, Ho, Er, Tm, Yb, Lu.

4. The CMAS-resistant multilayer structure of claim 1, wherein the substrate comprises at least one of SiC and Si₃N₄.

5. The CMAS-resistant multilayer structure of claim 1, wherein a thickness of the CMAS-resistant topcoat layer is in a range of 10 μm to 2000 μm.

6. The CMAS-resistant multilayer structure of claim 1, wherein a thickness of the hermetic EBC layer is in a range of 10 μm to 1000 μm.

7. The CMAS-resistant multilayer structure of claim 1, wherein a thickness of the bond coating layer is in a range of 2 μm to 500 μm.

8. The CMAS-resistant multilayer structure of claim 1, wherein a thickness of the substrate is greater than 40 mil.
